(19) United States
(12) Patent Application Publication
(10) Pub. No.: US 2019/0168682 A1
(43) Pub. Date: Jun. 6, 2019

(54) IN-VEHICLE FIXING STRUCTURE

(71) Applicants: TOYOTA JIDOSHA KABUSHIKI KAISHA, Toyota-shi (JP); DENSO TEN Limited, Kobe-sjo (JP)

(72) Inventor: Masanobu WASHIO, Kobe-shi (JP)

(73) Assignees: TOYOTA JIDOSHA KABUSHIKI KAISHA, Toyota-shi (JP); DENSO TEN Limited, Kobe-shi (JP)

(21) Appl. No.: 16/201,630

(22) Filed: Nov. 27, 2018

(30) Foreign Application Priority Data
Dec. 1, 2017 (JP) 2017-232023

(51) Int. Cl. B60R 11/02; B65G 13/06; B65G 39/18; G06F 1/16

(52) U.S. Cl. CPC B60R 11/02; B65G 13/065; B60R 2011/0005; G06F 1/1633; B65G 39/18

(57) ABSTRACT

An in-vehicle fixing structure for a small information terminal includes an insertion portion, a housing accommodating, and a controller. The controller controls the conveying roller to automatically convey the small information terminal to the normal position in a case where the small information terminal abuts the stopper, controls the shutter to close the insertion slot in a case where the sensor detects that the small information terminal has been automatically conveyed to the normal position after the automatic conveyance of the small information terminal by the conveying roller is started, and controls the connector connection device to connect the small information terminal and the external device to each other by moving the connector of the external device toward the connector of the small information terminal and fitting the connector of the external device to the connector of the small information terminal after the shutter closes the insertion slot.

### INCORPORATION BY REFERENCE

The disclosure of Japanese Patent Application No. 2017-232023 filed on Dec. 1, 2017 including the specification, drawings and abstract is incorporated herein by reference in its entirety.

### BACKGROUND

### 1. Technical Field

The present disclosure relates to an in-vehicle fixing structure for fixing a small information terminal in a vehicle.

### 2. Description of Related Art

A small information terminal such as a stick type personal computer (PC) or a card type personal computer (PC) attracts attention. Various uses are considered for the small information terminal, for example, it is conceivable to enjoy a high resolution movie, music, a video game, and the like by connecting the small information terminal to a car navigation device or the like.

However, in order to install the small information terminal in a vehicle, a countermeasure against vibration or the like is needed. In particular, it is needed to prevent poor contact, dropping, or the like due to vibration in a connector part or the like that connects the small information terminal and an electronic device in the vehicle (such as the car navigation device) to each other.

In order to reduce the vibration in the vehicle, for example, Japanese Unexamined Patent Application Publication No. 2003-314613 (JP 2003-314613 A) discloses a vibration-proof structure having an improved margin of vibration resistance, in which a hard disk drive (HDD) unit vulnerable to the vibration is detachably attached inside a casing of an in-vehicle electronic device (such as a navigation device) used under a harsh environment. In the vibration-proof structure as described above, vibration damping means (a vibration-proof rubber or the like) for damping the vibration is provided in a part where the HDD unit vulnerable to the vibration is mounted on a holder of the electronic device, the holder is guided to a storage position in the casing using a guide member, and an electrical connection is made to electrically operate the HDD unit as an internal component of the electronic device.

### SUMMARY

However, in the configuration of JP 2003-314613 A, a user himself has to attach and detach the HDD unit to and from the holder of the electronic device, resulting in a problem that complicated work is imposed. There is also a problem that the vibration resistance is not sufficient by providing the vibration damping means alone between the HDD unit and the electronic device. There is also a need for the small information terminal such as the stick type PC or the card type PC to be accommodated as compactly as possible in a limited space inside the vehicle.

The present disclosure provides an in-vehicle fixing structure capable of accommodating a small information terminal in a limited space inside a vehicle, while having sufficient vibration resistance.

An aspect of the present disclosure relates to an in-vehicle fixing structure for a small information terminal. The in-vehicle fixing structure includes an insertion portion including an insertion slot into which the small information terminal is inserted, a housing that accommodates the small information terminal inserted from the insertion slot, and a controller. The insertion portion includes a shutter configured to selectively close and open the insertion slot. The housing includes a guide rail, a stopper, a conveying roller, a sensor, and a connector connection device inside the housing. The guide rail is configured to guide the small information terminal. The stopper is configured to regulate manual pushing of the small information terminal. The conveying roller is configured to automatically convey the small information terminal to a predetermined normal position. The sensor is configured to detect whether the small information terminal has been automatically conveyed to the normal position. The connector connection device is configured to move a connector of an external device to a connector of the small information terminal, selectively fit the connector of the external device to the connector of the small information terminal, and separate the connector of the external device from the connector of the small information terminal. The controller is configured to control the conveying roller to automatically convey the small information terminal to the normal position in a case where the small information terminal abuts the stopper. The controller is configured to control the shutter to close the insertion slot in a case where the sensor detects that the small information terminal has been automatically conveyed to the normal position after the automatic conveyance of the small information terminal by the conveying roller is started. The controller is configured to control the connector connection device to connect the small information terminal and the external device to each other by moving the connector of the external device toward the connector of the small information terminal and fitting the connector of the external device to the connector of the small information terminal after the shutter closes the insertion slot.

In the in-vehicle fixing structure according to the aspect of the present disclosure, the controller may be configured to control the connector connection device to separate the connector of the external device from the small information terminal in a case where an instruction to release the connection between the small information terminal and the external device is received. The controller may be configured to control the shutter to open the insertion slot in a case where the connector of the external device is separated from the small information terminal. The controller may be configured to control the conveying roller to eject the small information terminal from the insertion slot after the insertion slot is opened.

In the in-vehicle fixing structure according to the aspect of the present disclosure, the controller may be configured to output an error message in a case where the connection between the small information terminal and the external device fails. The controller may be configured to control the shutter to open the insertion slot in a case where the connector of the external device is separated from the small information terminal. The controller may be configured to control the conveying roller to eject the small information terminal from the insertion slot after the insertion slot is opened.

In the in-vehicle fixing structure according to the aspect of the present disclosure, the guide rail may be configured to selectively hold both side surfaces and an upper surface of the small information terminal toward the center of the housing. The controller may be configured to control the guide rail to hold the both side surfaces and the upper surface of the small information terminal toward the center of the housing in a case where the small information terminal abuts the stopper.

In the in-vehicle fixing structure according to the aspect of the present disclosure, the guide rail may include a pair of guides having an inverted L-shape in a sectional view.

With the in-vehicle fixing structure according to the aspect of the present disclosure, it is possible to provide the in-vehicle fixing structure capable of accommodating the small information terminal in a limited space inside the vehicle, while having sufficient vibration resistance.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view illustrating an installation example of an in-vehicle fixing structure according to an embodiment;

FIG. 2 is a diagram schematically illustrating a main part of the in-vehicle fixing structure;

FIG. 3A is a perspective view illustrating a configuration of the main part of the in-vehicle fixing structure;

FIG. 3B is a view of the in-vehicle fixing structure illustrated in FIG. 3A as viewed in a direction α;

FIG. 3C is a view of the in-vehicle fixing structure illustrated in FIG. 3A as viewed in a direction β;

FIG. 4A is a perspective view illustrating a configuration of the main part of the in-vehicle fixing structure;

FIG. 4B is a view of the in-vehicle fixing structure illustrated in FIG. 4A as viewed in the direction α;

FIG. 4C is a view of the in-vehicle fixing structure illustrated in FIG. 4A as viewed in the direction β;

FIG. 5A is a perspective view illustrating a configuration of the main part of the in-vehicle fixing structure;

FIG. 5B is a view of the in-vehicle fixing structure illustrated in FIG. 5A as viewed in the direction α;

FIG. 5C is a view of the in-vehicle fixing structure illustrated in FIG. 5A as viewed in the direction β;

FIG. 6A is a perspective view illustrating a configuration of the main part of the in-vehicle fixing structure;

FIG. 6B is a view of the in-vehicle fixing structure illustrated in FIG. 6A as viewed in the direction α;

FIG. 6C is a view of the in-vehicle fixing structure illustrated in FIG. 6A as viewed in the direction β;

FIG. 7 illustrates a fixing processing flow;

FIG. 8 illustrates a release processing flow;

FIG. 9 is an explanatory diagram for describing an operation of a guide rail according to a modification example;

FIG. 10 illustrates a fixing processing flow according to the modification example; and

FIG. 11 is a diagram illustrating a stick type PC.

### DETAILED DESCRIPTION OF EMBODIMENTS

Hereinafter, an embodiment of the present disclosure will be described in detail below with reference to the drawings. In the following description, the same elements are denoted by the same reference numerals, and duplicate descriptions thereof will be omitted.

### A. Embodiment

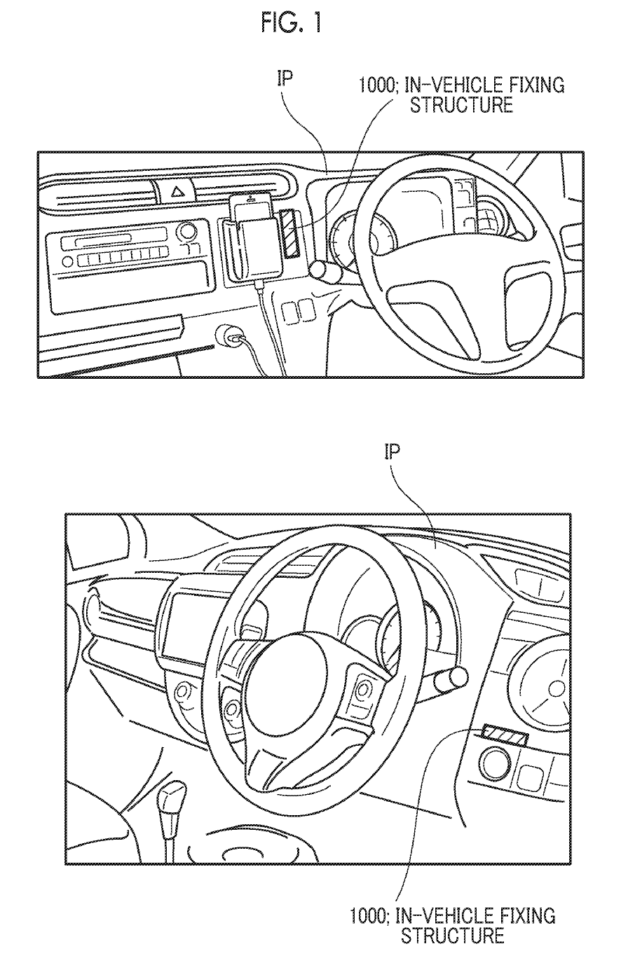

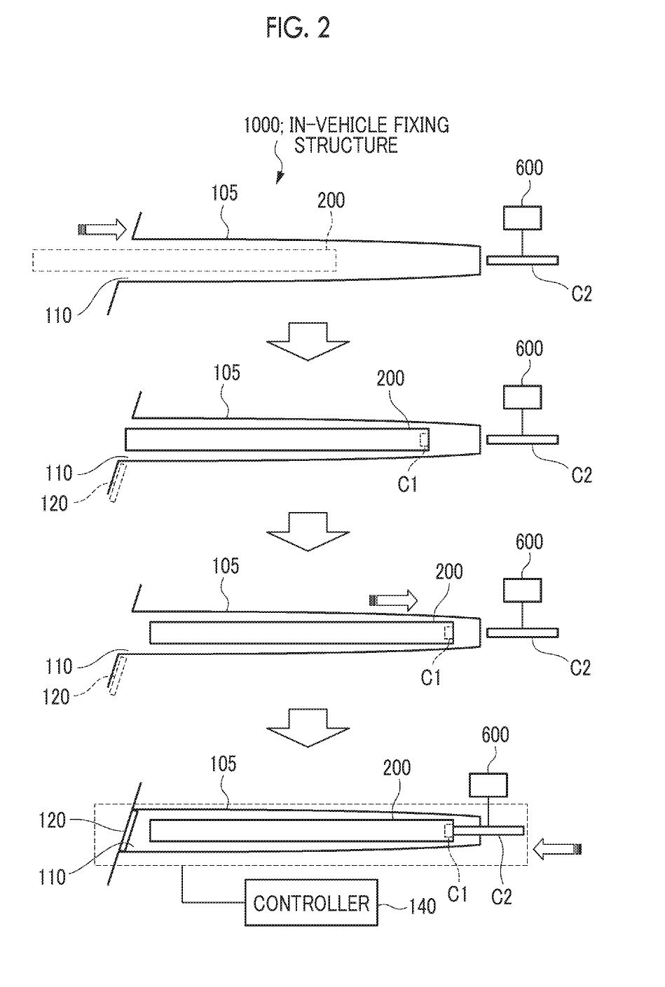

FIG. 1 is a view illustrating an installation example of an in-vehicle fixing structure 1000 according to the embodiment, and FIG. 2 is a diagram schematically illustrating a main part of the in-vehicle fixing structure 1000. The in-vehicle fixing structure 1000 according to the embodiment employs a slot-in system in which a small information terminal 200 is inserted into an insertion slot 110 without a tray (a drawer part). In the following description, a card type PC is assumed as an example of the small information terminal 200; however, the in-vehicle fixing structure is applicable to various electronic devices that can be brought into a vehicle, such as a tablet terminal, a wearable terminal, or an ultra small PC as well as a stick type PC (to be described later).

The in-vehicle fixing structure 1000 is provided in an instrument panel IP as illustrated in FIG. 1. In the embodiment, an entire dashboard including a glove compartment or an airbag module is referred to as an instrument panel.

The in-vehicle fixing structure 1000 is provided with a housing 105 that accommodates a card type PC 200 (see the first in FIG. 2). For example, the card type PC 200 is designed to have a body size of W; 945 mm, D; 55 mm, H; 5 mm, and is configured to include a processor including a central processing unit (CPU), a read only memory (ROM), a random access memory (RAM), and the like, various memories and storages, and various wireless communication devices (such as Wi-Fi and Bluetooth (registered trademark)).

A shutter 120 that regulates insertion and removal of the card type PC 200 into the housing 105 is provided in the insertion slot 110 of the in-vehicle fixing structure 1000 (see the second in FIG. 2). When the card type PC 200 is accommodated in the housing 105 (see the third in FIG. 2), the shutter 120 is closed and the card type PC 200 is locked in the housing 105 (see the fourth in FIG. 2).

A connector (for example, a universal serial bus (USB) type-C connector) C1 for connection with an external device 600 is provided on a rear surface portion of the card type PC 200 accommodated in the housing 105. The external device 600 is provided with a connector C2 for connection with the connector C1 of the card type PC 200. The external device 600 connected to the card type PC 200 is, for example, an electronic device such as a car navigation device, a liquid crystal panel, or a mobile terminal.

A controller 140 includes a micro control unit (MCU) or the like having a CPU, a ROM, a RAM, and the like as main components, and integrally controls each portion of the in-vehicle fixing structure 1000 by executing various programs and the like stored in the ROM and the RAM. In addition to control of an opening and closing operation of the shutter 120, the controller 140 takes a role of controlling a physical connection between the card type PC 200 and the external device 600 by moving the connector C2 of the external device 600 toward the connector C1 of the card type PC 200 (see the fourth in FIG. 2; details will be described later).

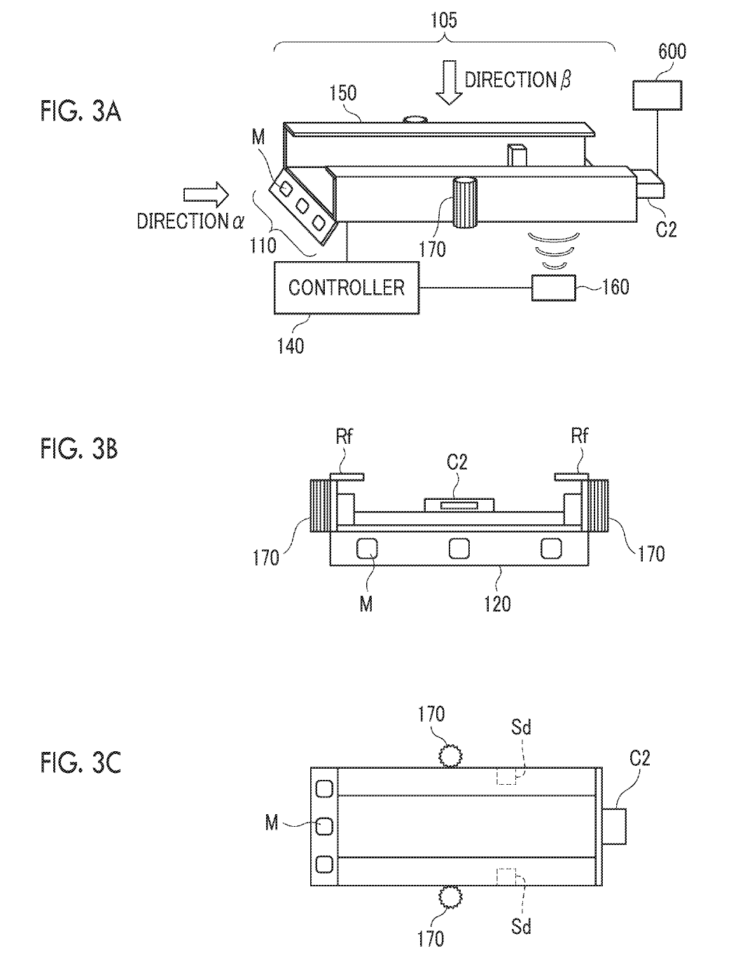

FIG. 3A to FIG. 6C are diagrams illustrating a configuration of the main part of the in-vehicle fixing structure 1000. FIGS. 3A, 4A, 5A, and 6A are perspective views of the in-vehicle fixing structure 1000, FIGS. 3B, 4B, 5B, and 6B are views of the in-vehicle fixing structure 1000 illustrated in each of FIGS. 3A, 4A, 5A, and 6A as viewed in a direction α, and FIGS. 3C, 4C, 5C, and 6C are views of the in-vehicle fixing structure 1000 illustrated in each of FIGS. 3A, 4A, 5A, and 6A as viewed in a direction β. The guide rail 150 is provided to cover side surfaces and a part of an upper surface of the card type PC 200 accommodated in the housing 105. As illustrated in FIG. 3B, the guide rail 150 is constituted by a pair of metal guides (a metal guide on a right side and a metal guide on a left side) having an inverted L-shape in a sectional view (in this specification, the meaning of the “inverted L-shape” includes “substantially inverted L-shape”).

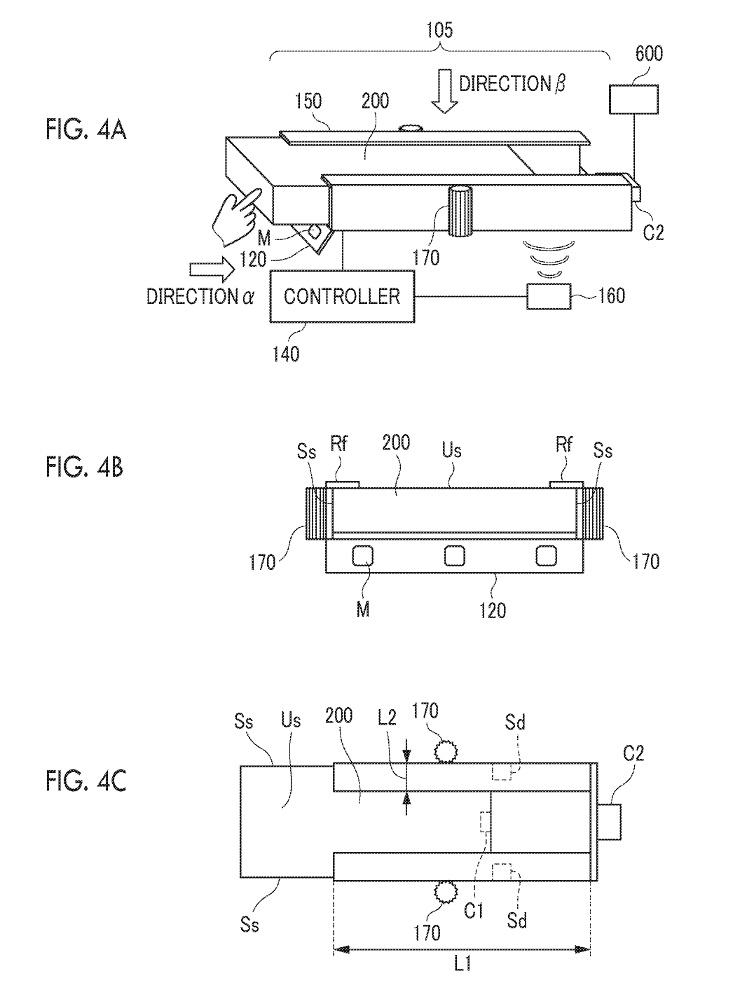

Under the control of the controller 140, the guide rail 150 guides the card type PC 200 into the housing 105 through the insertion slot 110. More specifically, the guide rail 150 regulates both side surfaces Ss of the inserted card type PC 200 and regulates an upper surface Us of the card type PC 200 (see FIG. 4B).

Here, not only the side surface Ss of the card type PC 200 but also the upper surface Us is regulated for the following reason. In other words, regulating the side surface Ss of the card type PC 200 using the guide rail 150 alone causes a vulnerability to vibration or the like in a vertical direction. Therefore, in the guide rail 150 according to the embodiment, not only the side surface Ss of the card type PC but also the upper surface Us is regulated by providing each of the metal guides with a roof portion Rf. A length L1 of the metal guide and a protruding length L2 of the roof portion Rf may be selected to be the optimum length for fixing the card type PC 200 (see FIG. 4C). A cushioning material (having heat resistance) or the like may be provided inside the guide rail 150 (that is, a part where the card type PC 200 abuts the guide rail 150).

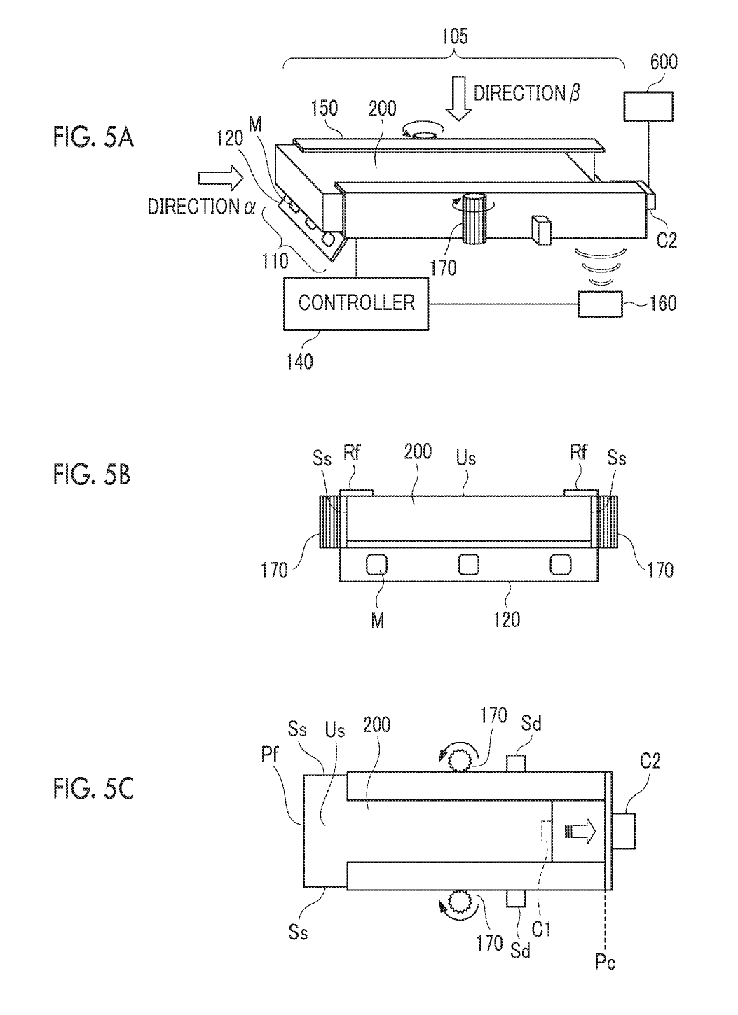

Conveying rollers 170 are provided at the approximate center of the both side surfaces Ss of the guide rail 150, respectively. Under the control of the controller 140, the conveying roller 170 takes a role of further pushing (automatically conveying) the manually pushed card type PC 200 to a position where the card type PC 200 can be connected to the external device 600 (hereinafter also referred to as “normal position Pc”) (see FIG. 5C). More specifically, detection stoppers Sd for detecting the card type PC 200 are provided inside the both side surfaces Ss of the guide rail 150 in the housing 105. When detection is made that the card type PC 200 has been pushed to a position where the card type PC 200 abuts the detection stopper Sd (see FIGS. 4A to 4C), the controller 140 starts rotation of the conveying roller 170 and starts automatic conveyance of the card type PC 200 by the conveying roller 170 (see FIGS. 5A to 5C). The embodiment exemplifies a case where a pair of the detection stoppers Sd is provided closer to the external device 600 than the approximate center of the guide rail 150; however, the detection stopper Sd may be provided at any position. A conveyance amount, a conveyance speed, and the like of the card type PC 200 by the conveying roller 170 may be determined depending on a distance from an installation position of the detection stopper Sd to the normal position Pc or the like.

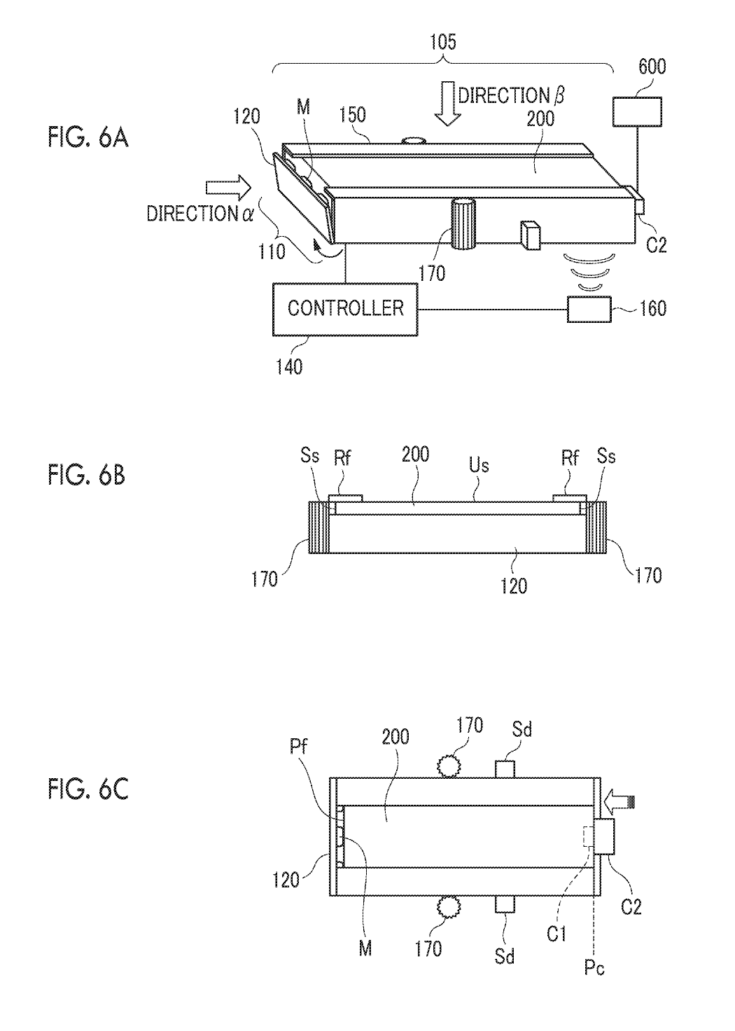

A card detection sensor 160 is a sensor for detecting whether or not the card type PC 200 has reached the normal position Pc and can use a camera (such as a CMOS camera) or an infrared sensor, for example. When detection is made that the card type PC 200 has reached the normal position Pc (see FIGS. 6A to 6C), the card detection sensor 160 transmits a signal indicating that detection has been made (hereinafter also referred to as a “detection signal”) to the controller 140. When the detection signal from the card detection sensor 160 is received, the controller 140 stops the rotation of the conveying roller 170, ends the automatic conveyance of the card type PC 200 by the conveying roller 170, and closes the shutter 120 provided in the insertion slot 110, and thus a front end portion Pf of the card type PC 200 is fixed from a rear so as not to pop out of the insertion slot 110 (see FIGS. 6A to 6C). In the embodiment, a fixing material (such as the cushioning material) M is provided on a back surface of the shutter 120; however, the fixing material may not be provided.

When the shutter 120 is closed and the card type PC 200 accommodated in the housing 105 is fixed, the controller 140 automatically connects the card type PC 200 and the external device 600 to each other by moving the connector C2 of the external device 600 toward the connector C1 provided on the rear surface portion of the card type PC 200.

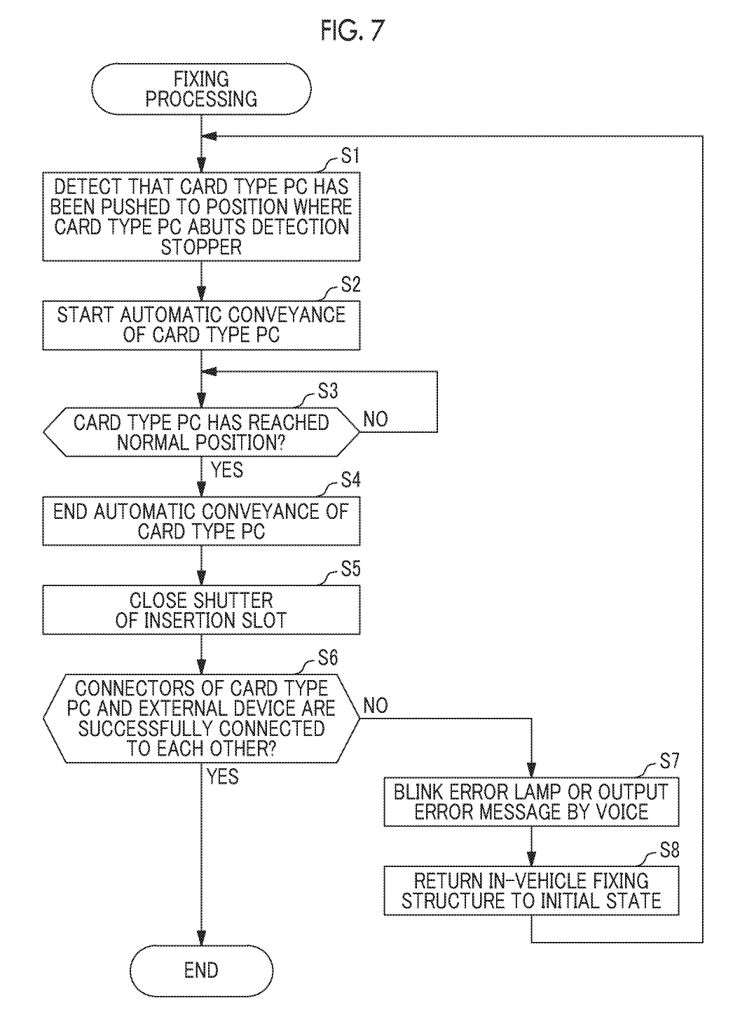

Hereinafter, a flow until the card type PC 200 brought into the vehicle by the user or the like is connected to the external device 600 will be described with reference to FIGS. 4A to 7. FIG. 7 illustrates a fixing processing flow executed by the controller 140. It is assumed that the shutter 120 is open in an initial state before the card type PC 200 is inserted into the in-vehicle fixing structure 1000.

The user or the like manually inserts the card type PC 200 into the insertion slot 110 (see FIGS. 4A to 4C). When detection is made that the inserted card type PC 200 has been pushed to the position where the card type PC 200 abuts the detection stopper Sd (step S1: see FIGS. 5A to 5C), the controller 140 starts the rotation of the conveying roller 170 and starts the automatic conveyance of the card type PC 200 by the conveying roller 170 (step S2: see FIGS. 6A to 6C), while the card detection sensor 160 starts detection as to whether or not the card type PC 200 has reached the normal position Pc (that is, the position where the card type PC 200 can be connected to the external device 600) (step S3). In a case where the detection signal indicating that the card type PC 200 has reached the normal position Pc is not received from the card detection sensor 160 (step S3: NO), the controller 140 repeatedly executes the processing of step S3.

Thereafter, when the detection signal indicating that the card type PC 200 has reached the normal position Pc is received from the card detection sensor 160 (step S3: YES), the controller 140 stops the rotation of the conveying roller 170 and ends the automatic conveyance of the card type PC 200 by the conveying roller 170 (step S4). Then, the controller 140 closes the shutter 120 provided in the insertion slot 110 (step S5) to fix the front end portion Pf of the card type PC 200 from the rear so as not to pop out of the insertion slot 110 (see FIGS. 6A to 6C).

When the card type PC 200 accommodated in the housing 105 is fixed, the controller 140 fits the card type PC 200 to the external device 600 by moving the connector C2 of the external device 600 toward the connector C1 provided on the rear surface portion of the card type PC 200, and attempts to provide the connection between the connectors (step S6). When the connectors of the card type PC 200 and the external device 600 are successfully connected to each other (step S6: YES), the controller 140 ends the above-described processing.

Meanwhile, when the connection between the connectors of the card type PC 200 and the external device 600 fails due to some factors (for example, an orientation of the card type PC 200 is incorrect, front and back sides thereof are reversed, the type of the card is different, or the like) (step S6: NO), an error lamp is blinked, or an error message by a voice is output by the controller 140 (step S7). Then, after the shutter 120 is opened, the controller 140 ejects the card type PC 200 from the insertion slot 110 by reversely rotating the conveying roller 170 to return the in-vehicle fixing structure 1000 to the initial state (step S8) and then the processing returns to step S1. According to the error message or the like, the user removes the ejected card type PC 200 to correct the orientation of the card type PC 200, and then reinserts the card type PC 200 into the insertion slot 110. When detection is made that the inserted card type PC 200 has been pushed to the position where the card type PC 200 abuts the detection stopper Sd (step S1), the controller 140 starts the rotation of the conveying roller 170 and starts the automatic conveyance of the card type PC 200 by the conveying roller 170 (step S2). The subsequent operation can be described in the same manner as the above-described series of the processing, so the description thereof will be omitted.

As described above, according to the embodiment, it is possible to accommodate the card type PC 200 in a limited space inside the vehicle by employing the in-vehicle fixing structure 1000 for the small information terminal. In the card type PC 200 accommodated in the in-vehicle fixing structure 1000, since the side surfaces and upper surface of the card type PC 200 are regulated by the guide rail 150 provided with the roof portion Rf and having the substantially inverted L-shape in the sectional view, the vibration can be suppressed. The card type PC 200 and the external device 600 are reliably connected to each other by moving the connector C2 of the external device 600 toward the connector C1 of the card type PC 200. For this reason, it is possible to prevent in advance the problem such as connectors separating from each other from occurring due to incomplete connection between the connectors.

In the above embodiment, the case where the card type PC 200 and the external device 600 are connected to each other has been described; however, the operation in a case of releasing the connection between the card type PC 200 and the external device 600 can also be similarly described.

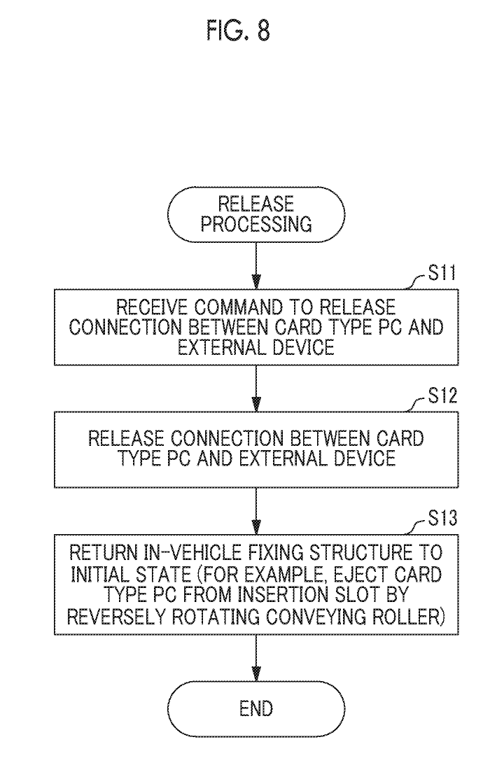

FIG. 8 illustrates a release processing flow executed by the controller 140. When a command to release the connection between the card type PC 200 and the external device 600 is received (step S11), the controller 140 separates the connector C2 of the external device 600 from the card type PC 200 (step S12).

Then, after the shutter 120 is opened, the controller 140 ejects the card type PC 200 from the insertion slot 110 by reversely rotating the conveying roller 170 to return the in-vehicle fixing structure 1000 to the initial state (step S13), and then ends the processing. A configuration may be employed for the command to release the connection between the card type PC 200 and the external device 600 to be output to the controller 140, for example, in a case where an accessory (ACC) power supply is turned off or a case where the user performs a predetermined manipulation.

In the above embodiment, the metal guides having the roof portion Rf covering a part of the upper surface Us of the card type PC 200 have been exemplified; however, for example, the metal guides having the roof portion Rf that covers an entire upper surface Us of the card type PC 200 may be provided.

A first guide that regulates the both side surfaces Ss of the card type PC 200 and a second guide that regulates the upper surface Us of the card type PC 200 may be configured to be independently provided.

Since it is possible to reduce the vibration with the first guide that regulates the both side surfaces Ss of the card type PC 200, the second guide that regulates the upper surface Us of the card type PC 200 may be omitted. For example, instead of providing the metal guides having the substantially inverted L-shape in the sectional view, the metal guides having a substantially I-shape in the sectional view may be provided.

In a case where the in-vehicle fixing structure 1000 for the small information terminal is employed, there may occur a situation where the card type PC 200 accommodated in the housing 105 cannot be normally removed for some reason (for example, a contamination by a foreign matter). In order to cope with such the situation, an emergency removal function of the card type PC 200 may be employed in the in-vehicle fixing structure 1000. Specifically, a manipulation mechanism capable of manually rotating the conveying roller 170 is provided in the in-vehicle fixing structure 1000. In a case where the situation that the card type PC 200 accommodated in the housing 105 cannot be normally removed occurs, it is possible to forcibly eject the card type PC 200 accommodated in the housing 105 by reversely rotating the conveying roller 170 using the manipulation mechanism.

In the above embodiment, the configuration is employed, in which the automatic conveyance of the card type PC 200 by the conveying roller 170 is started in a case where the detection is made that the card type PC 200 has been pushed to the position where the card type PC 200 abuts the detection stopper Sd; however, a configuration may be employed, in which the automatic conveyance of the card type PC 200 by the conveying roller 170 is started, the detection stopper Sd not being provided. For example, in a case where a sensor that detects the card type PC 200 having been pushed to a predetermined position is provided, and the sensor detects that the card type PC 200 has been pushed to the predetermined position, the automatic conveyance by the conveying roller 170 may be started.

### B. Modification Example

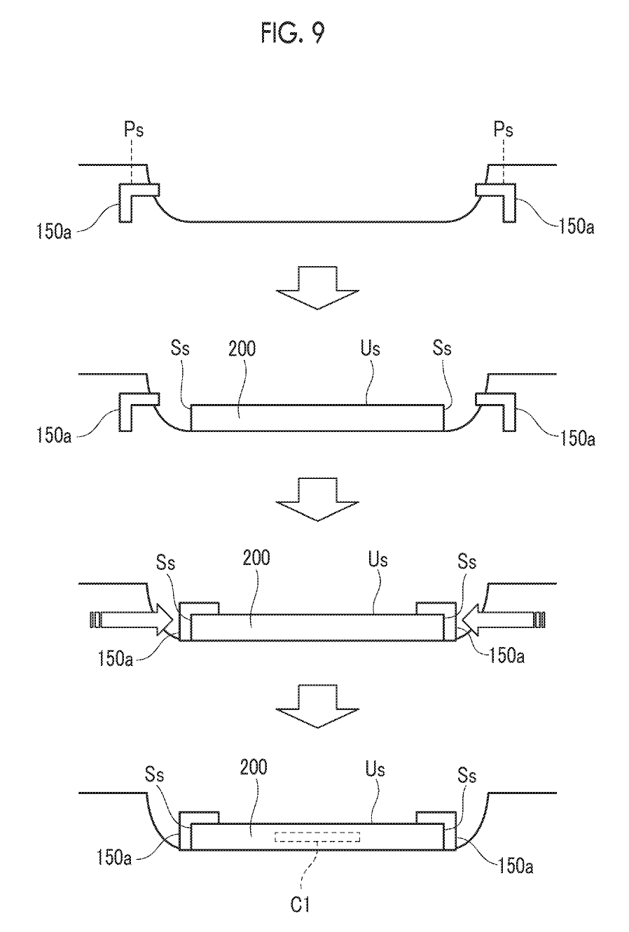

FIG. 9 is an explanatory diagram for describing an operation of a guide rail 150a according to a modification example. Under the control of the controller 140, the guide rail 150a holds the both side surfaces Ss of the card type PC 200 inserted in the insertion slot 110 toward the center in a right-left direction, and holds the upper surface Us of the card type PC 200 toward the center (hereinafter, referred to as a “holding operation”), and thus suppressing the vibration of the card type PC 200. The guide rail 150a starts the holding operation of the card type PC 200 by moving toward the center from an initial position Ps illustrated in the first of FIG. 9 in a case where the card type PC 200 abuts the detection stopper Sd (to be described later).

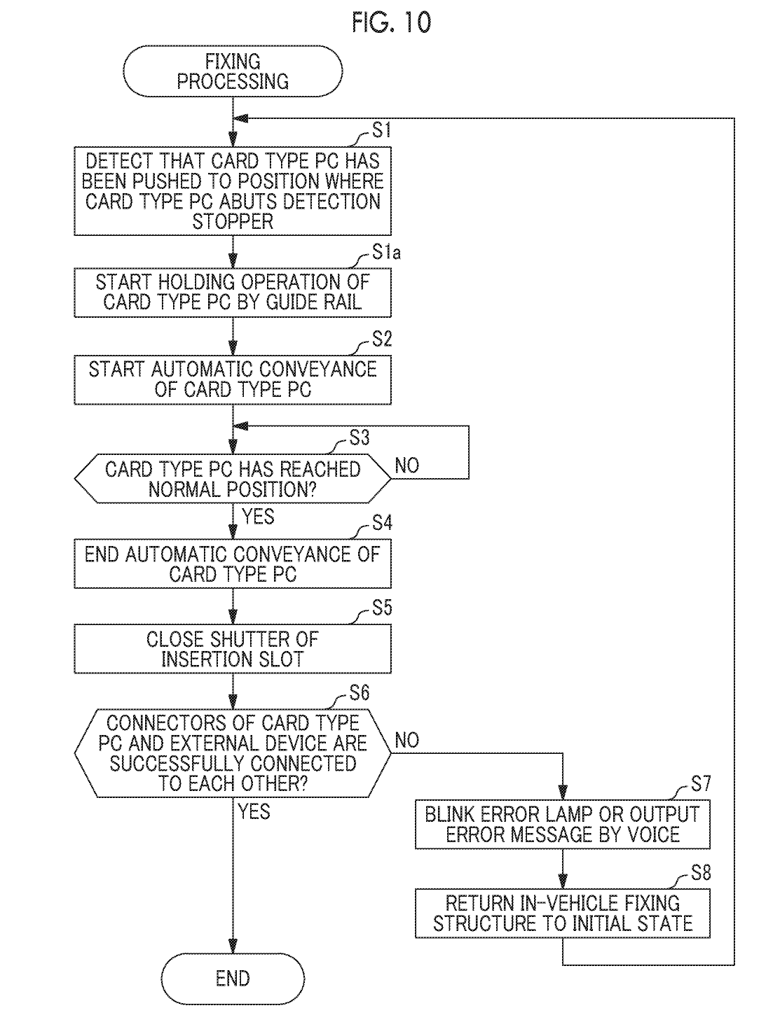

Hereinafter, a flow until the card type PC 200 brought into the vehicle by the user or the like is connected to the external device 600 will be described with reference to FIGS. 9 and 10. FIG. 10 illustrates a fixing processing flow executed by the controller 140 according to the modification example. Of the steps illustrated in FIG. 10, those corresponding to the steps illustrated in FIG. 7 are denoted by the same reference numerals, and a detailed description thereof will be omitted.

The user or the like manually inserts the card type PC 200 into the insertion slot 110. When the detection is made that the inserted card type PC 200 has been pushed to the position where the card type PC 200 abuts the detection stopper Sd (step S1), the controller 140 first starts the holding operation of the card type PC 200 by the guide rail 150a (step S1a). More specifically, the controller 140 controls the guide rail 150a to hold both side surfaces Ss of the card type PC 200 toward the center in the right-left direction, and to hold the upper surface Us of the card type PC 200 toward the center. Thereafter, the controller 140 starts the rotation of the conveying roller 170, and starts the automatic conveyance of the card type PC 200 by the conveying roller 170 (step S2). Since the operation after automatic conveyance of the card type PC 200 by the conveying roller 170 is started can be described in the same manner as in the embodiment, further description thereof will be omitted.

As described above, according to the modification example, in addition to the configuration of the above embodiment, by employing the configuration in which the card type PC 200 is held from right and left and from above by the guide rail 150a, it is possible to reliably fix the card type PC 200 at the normal position while the vibration is suppressed.

In the modification example, the holding operation of the card type PC 200 by the guide rail 150a is started in a case where the inserted card type PC 200 abuts the detection stopper Sd; however, before the card type PC 200 abuts the detection stopper Sd, the holding operation of the card type PC 200 by the guide rail 150a may be started. For example, the holding operation of the card type PC 200 by the guide rail 150a may be started in a case where the card detection sensor detects the insertion of the card type PC 200. Any card detection sensor may be used as long as the card detection sensor can detect the insertion of the card type PC 200 into the in-vehicle fixing structure 1000. Indeed, in a case where the camera is used as the card detection sensor, not only the insertion of the card type PC 200 but also whether the card type PC 200 is inserted in the correct orientation (that is, whether the rear surface portion of the card type PC 200 is placed so as to face the connector C2 of the external device), whether the front and back sides of the card type PC 200 are correctly mounted, and furthermore, whether the type of the card type PC 200 is correct or the like, can be detected. In a case where the card detection sensor detects the errors, the controller 140 may provide an alarm of an error message (for example, the output of the voice message, or the blinking of the error lamp).

### C. Others

An applicable embodiment of the present disclosure is not limited to the above-described embodiment and modification example, and may be implemented in various other forms within the scope without departing from the gist of the present disclosure.

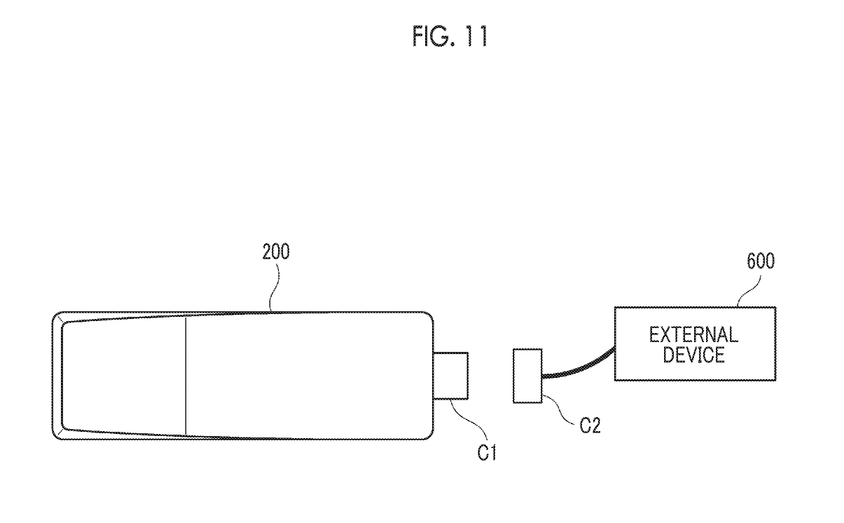

In the embodiment and modification example, the case where the card type PC 200 as illustrated in FIG. 2 is fixed has been described; however, similar description is possible also for a case of fixing the stick type PC 200 as illustrated in FIG. 11. For example, the connector C1 conforming to high-definition multimedia interface (HDMI: registered trademark) is provided in the rear surface portion of the stick type PC 200. The connector C2 conforming to the HDMI is provided in the external device 600. The stick type PC 200 and the external device 600 can be reliably connected to each other by moving the connector C2 of the external device 600 toward the connector C1 of the stick type PC 200 and fitting the stick type PC 200 to the external device 600. In the above example, the aspect in which the connector C1 is provided in each rear surface portion of the card type PC 200 and the stick type PC 200 has been exemplified; however, an aspect that the connector C1 is provided in a portion except the rear surface portion may be employed.

Order of the steps in each processing described above in the specification can be optionally changed or executed in parallel as long as there is no inconsistency in the processing contents.

A program implementing each processing described in the specification may be stored in a recording medium. The program can be installed in a computer constituting the in-vehicle fixing structure 1000 by using the recording medium. Here, the recording medium storing the program may be a non-transitory recording medium. The non-transitory recording medium is not particularly limited, and it may be a recording medium such as a CD-ROM.

What is claimed is:

1. An in-vehicle fixing structure for a small information terminal, the in-vehicle fixing structure comprising:
an insertion portion including an insertion slot into which the small information terminal is inserted, the insertion portion including a shutter configured to selectively close and open the insertion slot;
a housing that accommodates the small information terminal inserted from the insertion slot, the housing including a guide rail, a stopper, a conveying roller, a sensor, and a connector connection device inside the housing, the guide rail being configured to guide the small information terminal, the stopper being configured to regulate manual pushing of the small information terminal, the conveying roller being configured to automatically convey the small information terminal to a predetermined normal position, the sensor being configured to detect whether the small information terminal has been automatically conveyed to the normal position, the connector connection device being configured to move a connector of an external device to a connector of the small information terminal, selectively fit the connector of the external device to the connector of the small information terminal, and separate the connector of the external device from the connector of the small information terminal; and
a controller configured to
control the conveying roller to automatically convey the small information terminal to the normal position in a case where the small information terminal abuts the stopper,
control the shutter to close the insertion slot in a case where the sensor detects that the small information terminal has been automatically conveyed to the normal position after the automatic conveyance of the small information terminal by the conveying roller is started, and
control the connector connection device to connect the small information terminal and the external device to each other by moving the connector of the external device toward the connector of the small information terminal and fitting the connector of the external device to the connector of the small information terminal after the shutter closes the insertion slot.

2. The in-vehicle fixing structure according to claim 1, wherein the controller is configured to
control the connector connection device to separate the connector of the external device from the small information terminal in a case where an instruction to release the connection between the small information terminal and the external device is received,
control the shutter to open the insertion slot in a case where the connector of the external device is separated from the small information terminal, and
control the conveying roller to eject the small information terminal from the insertion slot after the insertion slot is opened.

3. The in-vehicle fixing structure according to claim 1, wherein the controller is configured to
output an error message in a case where the connection between the small information terminal and the external device fails,
control the shutter to open the insertion slot in a case where the connector of the external device is separated from the small information terminal, and
control the conveying roller to eject the small information terminal from the insertion slot after the insertion slot is opened.

4. The in-vehicle fixing structure according to claim 1, wherein:
the guide rail is configured to selectively hold both side surfaces and an upper surface of the small information terminal toward a center of the housing; and
the controller is configured to control the guide rail to hold the both side surfaces and the upper surface of the small information terminal toward the center of the housing in a case where the small information terminal abuts the stopper.

5. The in-vehicle fixing structure according to claim 4, wherein the guide rail includes a pair of guides having an inverted L-shape in a sectional view.
